(19) United States
(12) Patent Application Publication
(10) Pub. No.: US 2025/0019290 A1
(43) Pub. Date: Jan. 16, 2025

(54) Increasing Tortuosity To Decrease Heat Transfer In Hollow Structures By Shaping The Hollow Structures, A Process That Entails Distribution Of Forces During Transformation Of Seeds

(71) Applicant: Plassein Technologies Ltd. LLC, Las Vegas, NV (US)

(72) Inventor: David Charles Lynch, Kingsport, TN (US)

(21) Appl. No.: 18/748,060

(22) Filed: Jun. 19, 2024

Related U.S. Application Data
(60) Provisional application No. 63/525,143, filed on Jul. 5, 2023.

(51) Int. Cl. C03B 19/08

(52) U.S. Cl. CPC C03B 19/08

(57) ABSTRACT

Methods are presented for altering the thermal conductivity of a material consisting of sealed and hollow structures by altering their shape to impact heat transfer through increasing tortuosity and altering molecular behavior of gas within the hollow structures. Procedures are presented whereby desired shape of the hollow structures can be formed as seeds and are transformed into the sealed and hollow structures that constitute VacuBoards and HollowBoards. Techniques are presented to prevent the impact of gravitational forces that can collapse hollow structures during their formation and cooling.

### RELATED APPLICATIONS

The present application claims the benefit of copending U.S. Provisional Application No. 63/525,143, filed on Jul. 5, 2023 by at least one common inventor and entitled “Increasing Tortuosity To Decrease Heat Transfer In Hollow Structures By Shaping The Hollow Structures, A Process That Entails Distribution Of Forces During Transformation Of Seeds”, which is incorporated herein by reference in its entirety.

### BACKGROUND OF THE INVENTION

### Field of the Invention

This invention relates generally to hollow spheres, and more particularly to the production and use of hollow spheres.

### Description of the Background Art

Hollow spheres are sold by at least four companies, CenoStar, Petra, Potters, and 3M. CenoStar and Petra harvest hollow spheres from coal fired power plant waste. Those aluminosilicate spheres have a maximum operational temperature of approximately 1040° C. or below depending on composition. Petra, along with 3M, sells hollow spheres formed from soda-lime borosilicate glass with a maximum operational temperature of about 600° C. Potters sells hollow glass spheres but does not provide information as to the composition of the glass or indicate that the spheres can be used at any elevated temperature. Hollow spheres sold by CenoStar, Petra, and 3M have an internal gas pressure of 0.25 atmospheres or greater, a condition that impacts their thermal conductivity.

Methods for synthesizing hollow silica spheres have been a topic of research since 1968, gaining greater interest as the field of nanomaterials has advanced. In known methods for synthesizing hollow spheres, a preform is created and silica is deposited around the form by chemical processes. The interior preform is removed by either chemical reaction or firing at temperatures up to 500° C. The latter technique has proved more successful in retaining the hollow spherical shape. Scanning electron microscopy reveals that the wall structure of the hollow spheres consists of smaller spheres of silica. The micrographs also reveal that the wall of a sphere formed by such synthesis is porous. Formation of hollow spheres at low temperatures reduces their strength, and thus limits their use.

Poraver produces “Expanded Glass” which is a foam formed by mixing particles of calcium carbonate in molten recycled glass and then heating that mixture to 900° C. to decompose the carbonate and thereby form the foam. The maximum operational temperature for the foam is approximately 700° C. Lack of uniformity in the size and distribution of hollow spaces limits their structural use, and the presence of an internal gaseous environment of carbon dioxide at 0.25 atm impacts their thermal conductivity.

There are two forms of metal foam, metal sponge and composite metal foam (CMF). The latter consists of aluminum cast around hollow steel balls. Metal sponge is the most common form of metal foam, primarily involving aluminum and large open cells produced by the following process:
Casting molten metal around a form (e.g. powdered salt) that is later leached;
Adding thickeners (e.g. powdered ceramics) to raise the viscosity of the metal then blowing gas through the mix as the metal solidifies; and
Adding hydride or mercury as a gas generator to the metal as it begins to solidify.
   Production methods for Metal Sponge yield a lack of uniformity with open pores.

Ceramic foam is produced by casting ceramic slip around a polymer form (usually beads). The beads are removed during an initial low temperature firing of the casting to burn off the polymer in the form and drive off moisture in the slip before sintering the ceramic powder.

Aerogels are very expensive, very weak, and contain a gas that impacts their thermal conductivity.

The American Ceramic Society featured an article on their web site entitled “Preparing for winter—hollow silica particles could form the basis of next-generation thermal insulation systems.” That article summarized information presented in “A lightweight thermally insulating and moisture-stable composite made of hollow silica particles,” J. Sharma et al., in RSC Advances, 2022, 12, p. 15373-15377 and “Creation of Hollow Silica—Fiberglass Soft Ceramics for Thermal Insulation,” S. Liu et al., in Pre-Proof released by the Chemical Engineering Journal (2022), doi: https://doi.org/10.1016/j.cej.2022.140134.

The goal of the investigators in the two cited references is to produce solid insulating composite containing porous hollow silica spheres, hollow spheres added to the composite mixture in powder form that produces a solid material with a thermal conductivity approaching that of the hollow spheres. This methodology places a lower limit on the thermal conductivity associated with the porous hollow silica spheres.

### SUMMARY

In the present invention the limiting thermal conductivity of the prior art is removed by producing seeds that, upon transformation, form hollow structures that impact thermal conductivity. Methods are presented for altering the thermal conductivity of a material consisting of sealed and hollow structures by altering their shape to impact heat transfer through increasing tortuosity and altering molecular behavior of gas within the hollow structures. Procedures are presented whereby desired shape of the hollow structures can be formed as seeds and are transformed into the sealed and hollow structures that constitute VacuBoards and HollowBoards. Techniques are presented to prevent the impact of gravitational forces that can collapse hollow structures during their formation and cooling.

An example method includes the production of a composite of hollow structures with internal pressures below 10⁻³ bar (VacuBoards) that have low thermal conductivities (high R-values) by increasing the length of the path (tortuosity) heat must follow to pass through the composite. Example methods advantageously utilize techniques for printing seeds prior to transforming them into the hollow structures that form a Board.

Another example method includes the production of a composite of hollow structures with internal pressures at and above 10⁻³ bar (Hollow Boards) that have low thermal conductivities (high R-values) by increasing the length of the path (tortuosity) heat follows to pass through the composite of hollow structures and by transitioning the behavior of the gas molecules in the hollow structures from free molecular movement to Knudsen flow. This example method advantageously utilizes techniques for printing seeds prior to transforming them into the hollow structures that form a Board.

Another example method includes balancing of forces that can collapse the hollow structures as seeds are transformed into Boards, as well as during their cooling.

In the foregoing disclosure, Boards (capitalized) is used to generically refer to VacuBoards and HollowBoards. When specificity is required the individual type of board is identified. Additionally, the phrase “hollow structure” is used as shorthand notation for “sealed and hollow structure.”

An example method includes printing multiple layers of seeds so that upon transforming the seeds into hollow structures in a confined horizontal space it is possible to produce Boards consisting of many layers. In a particular example method the Boards include a plurality of layers. In a more particular example method, each of the layers consists of many hollow structures. In an even more particular example method, each hollow structure has a void space containing a gas of variable pressure. In another even more particular example method, each void in the hollow structure has an Aspect Ratio of height to a horizontal dimension. In yet an even more particular example method, the magnitude of the Aspect Ratio is controlled by the printing of the seeds and the mass of the core that generates gas upon transformation. In another more particular example method, the center of the hollow structures can be offset from each other as a result of the printing of seeds. In an even more particular example method, the offset can be every other layer or more than every other layer.

In another particular example method, heat transfer through a Board, in the direction associated with the numerator of the Aspect Ratio, is impacted by the magnitude of the Aspect Ratio. In particular, heat transfer associated with the gas phase in the sealed voids can decrease with a decrease in the Aspect Ratio. Even more particularly, that decrease in heat transfer comes with a shift from free molecular movement of molecules in the gas to Knudsen flow. The shift to Knudsen flow occurs with decrease in the numerator in the Aspect Ratio along with decreasing internal pressure in the voids in the hollow structures.

In another particular example method, heat transfer through a Board in the direction associated with the numerator of the Aspect Ratio is impacted by the magnitude of the Aspect Ratio and the offset of the center of the hollow structures between layers. In Boards with gases having a low pressure in the voids in the sealed structures heat transfer occurs along the walls of the hollow structures at temperatures where thermal radiation of heat is unimportant. In particular, the walls form a path for heat transfer. Even more particularly, decreasing the Aspect Ratio increases the horizontal length of the path the heat must follow to move vertically through the Board. An increase in the path length increases the tortuosity, thereby reducing the thermal conductivity of the Board. The reduction in the thermal conductivity raises the R-value of the Board.

In another example method, radiant heat transfer in the Boards can be reduced by a reflective coating (placed on the surface or within the board or within the walls forming the hollow structures), by using materials with low emissivity, and/or by including elemental species forming ions in the glass walls that absorb radiant energy, thereby blocking its transmission.

In another example method, during a step of converting seeds in multiple layers of hollow structures, the gravitational force associated with the mass of the layers above a lower layer can be prevented from collapsing the hollow structures in the lower layers. A particular example method includes distributing the gravitational force by printing and forming one or more rows of smaller hollow structures between layers of the larger hollow structures. The force exerted from the wall of a larger hollow structure should contact the roof of the smaller hollow structure to be able to transfer and distribute that force through its side walls. Another particular example method includes increasing the thickness of the walls and roof of lower layers of the hollow structures to withstand the gravitational forces. Another particular example method includes increasing the viscosity of the walls and roof of lower layers of hollow structures to withstand the gravitational forces.

Another particular example method includes, by allowing the gravitational forces to compress gases in the lower layers of the hollow structures, increasing the gas pressure within those hollow structures to counter the gravitational forces. This occurs if the rate of the back reaction producing the gas in the hollow structure is slow compared to the rate the gas is produced. Another particular example method includes, creating a thermal gradient across the layers of seeds as they are transformed. In a more particular example method, the temperature gradient can be imposed by differential heating between the top and bottom layers. In another more particular example method, the temperature gradient can be created by heat transfer from the tray to the lowest layer of seeds and by the endothermic reactions that occur in the cores decreasing the amount of heat that is transferred from a layer to the next higher layer, thereby cooling each layer to create a thermal gradient. In another more particular example method, the temperature of the lowest layer of seeds is greater than the temperature of the top layer of seeds during the transformation process. In yet another more particular example method, the higher temperature in the lower layers created by the thermal gradient produces a higher pressure of gas in each layer of hollow structures compared to the layer above it. The increased pressure in the lower layer counters the external pressure and the gravitational force the lower layer experiences from the layers above it as applied per unit area perpendicular to direction of the force.

In another example method, during cooling of transformed seeds in multiple layers of hollow structures (now Boards) the gravitational force associated with the mass of the layers above a lower layer can be prevented from collapsing the hollow structures in the lower layers. A particular example method utilizes a rapid quench to a temperature where the viscosity of the glass walls forming Boards is high enough to slow deformation associated with the gravitational forces to allow further cooling without significant altering of the hollow structures. Another particular example method includes reducing an external pressure during the cooling process. Yet another particular example method includes maintaining a temperature gradient with the lowest layer of transformed seeds in a Board having the highest temperature compared to the top layer in the Board.

Still another particular example method includes reducing the external pressure during the cooling process and maintaining a temperature gradient with the lowest layer of transformed seeds having the highest temperature. In a more particular example method, the reduced pressure is equal to or slightly less than the internal pressure in the hollow structures in the top layer. That pressure fixes the temperature of the top layer, a value that can be computed using chemical thermodynamics. In another more particular example method, the temperature of the lowest layer of the sealed and hollow spheres can be determined by knowledge of the external pressure and the magnitude of the gravitational forces applied per unit of perpendicular area of the lowest layer of the hollow structures. With that information, one can compute the temperature required at the bottom layer using chemical thermodynamics. In another more particular example method, as the temperature of the upper layer of the hollow structures drops, the external pressure must also decline to avoid collapse of that layer of hollow structures. The decrease in external pressure also requires a drop in the temperature at the bottom layer of the hollow structures to avoid their unwanted expansion. Initially, the temperature and pressure gradients across the Board require coordination to avoid collapsing the upper layer of hollow structures and the unwanted expansion of the hollow structures in the bottom layer. In yet another more particular example method, with continued cooling, the increase in the viscosity of the glass walls in the upper layer begins to fix the shape of the sealed voids and more aggressive cooling can be employed by lowering the temperature of the top layer. The external pressure can also be adjusted. In another particular example embodiment, once the temperature of the entire Board is reduced enough to where the increased viscosity of the walls of the hollow structures can greatly slow any collapse of the hollow structures, the Board can undergo one or more thermal soaks to relieve internal stress and homogenize the composition of the walls.

In another example method the desired shape of the hollow structures is obtained and retained during transformation. A particular example method includes printing cores in the desired shape in the printing of seeds. Another particular example method includes using horizontal restraints to confine expansion to the vertical direction during the transformation of seeds into hollow structures. Yet another particular example method includes increasing the viscosity of the walls of a hollow structure as it is formed during the transformation from a seed. A more particular example method includes placing a layer of silica powder or a high silica glass frit between seeds or in a portion of the coating material of the seed. The silica powder or the high silica glass frit can be applied to any portions of the coating material as necessary. In still another particular example method, during transformation, the coating material surrounding the core begins to form a glass, and, as the core generates a gas, the glass begins forming the wall of a hollow structure. As the glass forms, some of the silica powder or high silica glass frit begins to dissolve in the glass forming the wall and begins raising the viscosity of the glass wall as it forms. The increase in the viscosity of the glass wall slows any tendency for the glass wall to form any other shape than that associated with the printing of the core of the seed.

### BRIEF DESCRIPTION OF THE DRAWINGS

The present invention is described with reference to the following drawings, wherein like reference numbers denote substantially similar elements:

FIG. 1 is a side view of an insulating board;

FIG. 2 is a block diagram illustrating an example placement of hollow structures in the board of FIG. 1;

FIG. 3 is a block diagram illustrating another example placement of hollow structures in the board of FIG. 1;

FIG. 4 is a block diagram showing a system for generating the insulating board of FIG. 1;

FIG. 5 is a cross sectional view of a tray of FIG. 4; and

FIG. 6 is a cross sectional view of a plurality of example hollow structures in a board.

### DETAILED DESCRIPTION

The present invention overcomes the problems associated with the prior art, by providing methods for manufacturing an insulating board out of hollow structures. The hollow structures are positioned to facilitate improved thermal insulation by increasing the tortuosity of heat transfer through the board. In the following description, numerous specific details are set forth (e.g., specific temperatures, pressures, etc.) in order to provide a thorough understanding of the invention. Those skilled in the art will recognize, however, that the invention may be practiced apart from these specific details. In other instances, details of well-known material production practices (e.g., routine optimization) and components have been omitted, so as not to unnecessarily obscure the present invention.

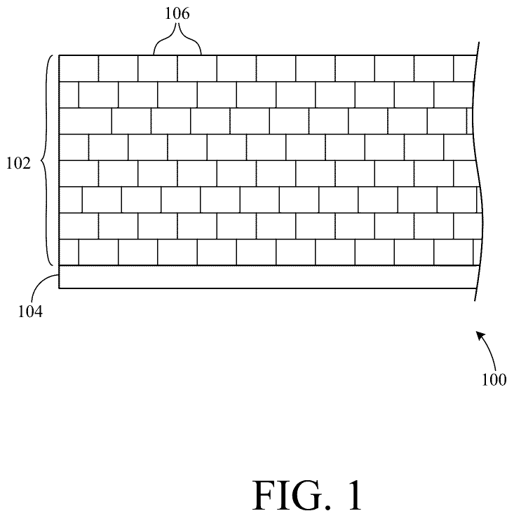

FIG. 1 shows a Board 100 including a honeycomb structure 102 and a reflective layer 104. Honeycomb structure 102 is comprised of a plurality of hollow silica structures 106, which are filled with a low pressure gas (e.g., at least an order of magnitude lower pressure than atmospheric pressure). Honeycomb structure 102 is configured to disrupt thermal conduction through the width of Board 100 and to disrupt thermal convection within structures 106. In an example embodiment, honeycomb structure 102 disrupts thermal conduction by increasing the tortuosity of heat through structures 106. Sidewalls of structures 106 are offset between adjacent vertical (i.e. in the direction of heat flow) layers of honeycomb structure 102 in order to eliminate any direct path of thermal conduction through Board 100. In the example, honeycomb structure 102 also disrupts thermal convection within the structures by significantly decreasing the pressure within structures 106. Reflective layer 104 is configured to prevent thermal radiation from passing through Board 100.

The example embodiment takes advantage of the phenomenon of Knudsen flow in order to minimize thermal convection within hollow structures 106. With decreasing pressure, free molecular movement of gaseous molecules gives way to Knudsen flow. Free molecular flow is characterized by molecules colliding with each other many more times than they collide with containment walls. The opposite is what happens with Knudsen flow. With decreasing pressure, the ratio of actual thermal conductivity to that associated with free molecular flow declines with decreasing pressure. The ratio of thermal conductivity of a gas at reduced pressure to that at a specified temperature and 1 atmosphere (known as the “Conductivity Ratio”) is a function of the “Pressure Parameter” which is the reduced pressure multiplied by the spacing between parallel walls and divided by the temperature, with the Parameter expressed in the units of Newton per meter per degree K. The thermal conductivity of CO2 in free molecular flow at 1 atm and 300 K is 0.0168 W/(m·K), at 0.25 atm and a spacing of 0.25 microns the “Pressure Parameter” is 2.1×10-5 N/(m·K) and at a spacing of 0.025 microns the parameter is 2.1×10-6 N/(m·K). From a graphical plot available in Fluid Flow Databook, General Electric, Genium Publishing, Section 410.2, May 1982, the Conductivity Ratio for the two reduced pressures are found to be 0.2 and 0.03. Multiplying those ratios by the conductivity of carbon dioxide in free molecular flow at the temperature of interest gives the thermal conductivity of the gas at the lower pressure and for the stipulated spacing between the walls of the sealed and hollow sealed structures. At 0.25 atm, 300K and a spacing of 0.25 microns, the thermal conductivity of CO2 is 0.0034 W/(m·K), and at a spacing of 0.025 microns the thermal conductivity is 0.00050 W/(m·K). Additional information regarding the generation of hollow spheres with reduced internal pressure can be found in U.S. patent application Ser. No. 17/468,138, filed by the same inventor and entitled “Methods for Producing and Products Including Hollow Silica or Hollow Glass Spheres”, which is incorporated herein by reference in its entirety.

For the example honeycomb structure 102, the limiting factor in reducing thermal conductivity is radiant heat transfer. Radiant heat transfer can occur through the glass walls of the sealed structures and through the sealed voids. At low temperatures, radiant heat transfer is small. For some example embodiments of the present application, at a fixed temperature differential, the magnitude of radiant heat transfer will remain constant while the R-value is increased. However, with increasing R-value, the percentage of radiant heat transfer with respect to total heat transfer increases as solid-state and natural convective heat transfer declines. Fortunately, radiant heat transfer can be reduced by a reflective coating placed on the surface of Board 102 (e.g., reflective layer 104), within the board, and/or within the walls forming the hollow structures. Through the use of materials with low emissivity, and through the inclusion of elemental species forming ions in the glass walls (e.g. of structures 106) that absorb radiant energy, the transmission of thermal radiation can be blocked.

Another important consideration regarding heat transfer across Board 100 is the Aspect Ratio (i.e., the ratio of the height to a horizontal dimension) of structures 106. By decreasing the Aspect Ratio (e.g., by decreasing the height, increasing the length, and/or increasing the width of structures 106) and offsetting the center of the hollow structures between layers, the horizontal distance the heat must travel increases significantly with respect to the vertical distance, thereby increasing the tortuosity and reducing the thermal conductivity of the collection of the hollow structures. This is particularly true for VacuBoards where the internal pressure in the sealed voids is small and the gas in the voids does not contribute significantly to heat transfer.

Scaled voids in HollowBoards, typically produced by the decomposition of calcium carbonate, contain CO₂ with a pressure of approximately 0.25 atm at 300K. As noted previously, at a spacing of 0.25 and 0.025 microns (in the direction of heat flow) the thermal conductivity of carbon dioxide is 20% and 3%, respectively, of the thermal conductivity of still CO₂(g). Decreasing the Aspect Ratio decreases the contribution of CO₂(g) to the thermal conductivity of HollowBoards. This impact of spacing on the thermal conductivity is not limited to carbon dioxide.

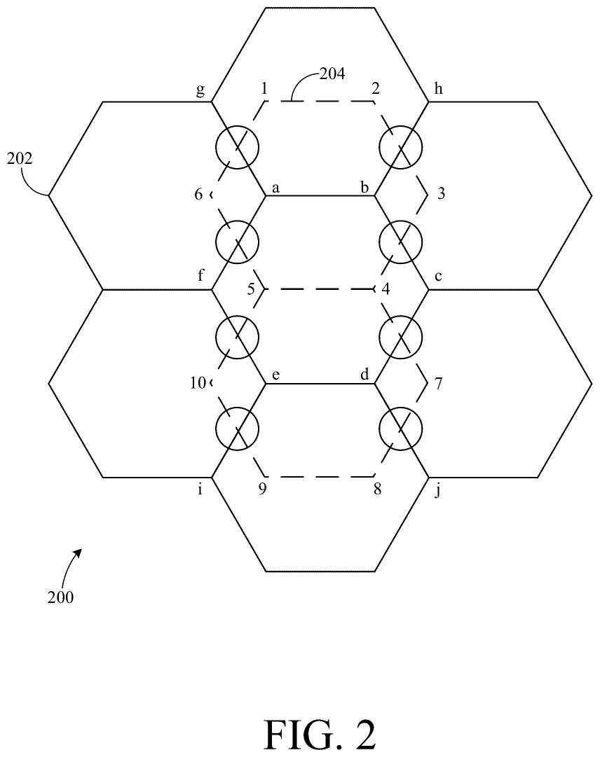

FIG. 2 shows an example honeycomb structure 200 including two layers. The walls of a lower layer 202 of hexagonal solids are represented by solid lines and identified by alphabetic letters. The walls of two hexagonal solids in an upper layer 204 are represented by dashed lines and numbers. The top and bottom of each hexagonal solid is sealed, thus the combination of wall segments a-b, b-c, c-d, d-e, e-f, and f-a represent the top and bottom sealed surface of the lower hexagonal structure. Second layer 204 is offset in the two horizontal directions. Multiple layers (only two shown), all or some, should be offset to achieve the desired reduction of their thermal conductivity. The bottom sealed layer of a hollow hexagonal solid in second layer 204 is represented by the wall segments 1-2, 2-3, 3-4, 4-5, 5-6, and 6-1. Those numbers also represent the top sealed surface of the hollow hexagonal solid.

In the following discussion, heat is moving upwards along the walls of honeycomb structure 200, but heat can also move downward through honeycomb structure 200. As an example, heat moves upwards along the wall a-b, and comes to the top of the structure that the wall a-b is part of. The heat can then move horizontally to any of the wall segments 1-2, 2-3, 3-4, 4-5, 5-6, and 6-1. Heat moving up the wall segment b-c will likely move to the wall segment 3-4, and the location where wall segments b-c and 3-4 cross allows for direct vertical heat transfer. (The locations where wall segments cross are circled in FIG. 2). That direct vertical heat transfer can be disrupted by a third offset layer of sealed and hollow hexagonal solids that do not align with first layer 202 or second layer 204. The presentation of layers 202 and 204 in FIG. 1 is not intended to be limiting, as many different shaped structures can be formed, offset in any desired direction, and repeated in any sequence.

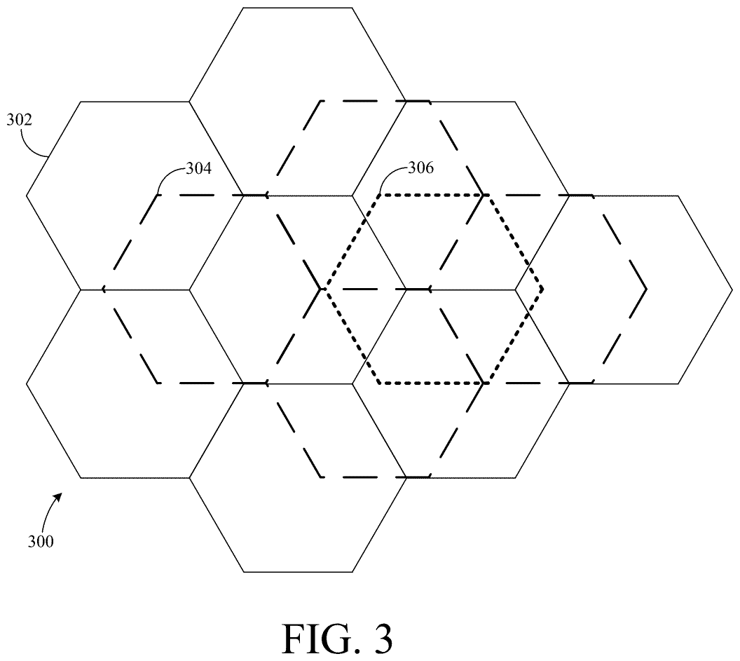

An example honeycomb structure 300 including three offset layers is presented in FIG. 3, wherein the different layers are represented by solid, dashed, and dotted lines, respectively. A first layer 302 is the bottom layer. A second layer 304 sits atop first layer 302. Second layer 304 is horizontally offset from first layer 302 in order to minimize the overlap of the vertical walls within the two layers. A third layer 306 sits atop second layer 304. Third layer 306 is horizontally offset from second layer 304 in order to maximize the required horizontal travel of heat through honeycomb structure 300. Because conductive heat can only transition between layers at the locations where the respective walls overlap, third layer 306 is positioned so that intersections between walls of first layer 302 and second layer 304 are offset significantly from intersections between walls of second layer 304 and third layer 306. This offset increases the tortuosity of heat through structure 300 and, thereby, the insulating properties of structure 300.

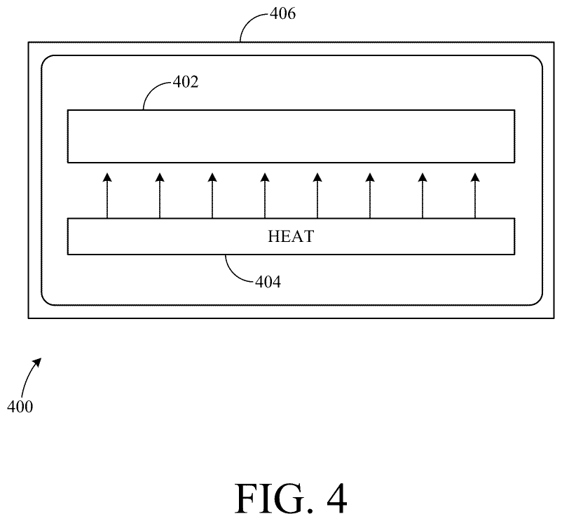

FIG. 4 shows an example system 400 for production of insulating boards according to novel methods disclosed herein. System 400 includes a tray 402, on which a plurality of seeds are printed using a Grid Surface Technique. A seed consists of a core and a coating. The core is selected from a material that reacts to generate gas upon heating of the seed. The coating surrounds the core and is selected from a material that reacts to form a continuous shell around the core (or gasses generated therefrom). A heat source 404 is utilized to apply heat evenly to an underside of tray 402. Upon reaching a sufficient temperature (which is dependent on pressure), the seeds transform into the hollow structures that comprise a Board. Because the transformation of the seeds depends on both temperature and pressure, system 400 includes a pressure regulating enclosure 406 that houses tray 402 and heat source 404. Enclosure 406 can be utilized advantageously for a variety of reasons including, but not limited to, increasing/decreasing the temperature required for a particular reaction, increasing/decreasing the viscosity of the seed coatings, increasing/decreasing the internal pressures of the hollow structures, and/or increasing/decreasing the pressure impinging on the outside of the hollow structures during formation. A person of ordinary skill in the art will recognize the advantages of these alternatives as well as others, particularly in view of the following description. Further information regarding the Grid Surface Technique (GST) can be found in U.S. patent application Ser. No. 18/234,856, filed by the same inventor and entitled “Methods for Producing Seed for Growth of Hollow Spheres”, which is incorporated herein by reference in its entirety. The referenced patent application describes the production of seeds and their transformation into hollow structures referred to as VacuBoards and HollowBoards.

There are a number of factors to consider during production of the example hollow structures described above. Forces on and/or within the structures can be advantageously counterbalanced. The weight of the hollow structures above a lower layer of hollow structures can produce compressive forces on the lower layer. That compressive force, during thermal processing, can be countered by at least two methods for controlling the internal pressure within the hollow structures. The two methods include natural compression and fixed pressure by a thermal gradient.

An example method of natural compression can utilize the weight of the hollow structures above a lower layer of sealed structures to compress the volume of the lower layer of hollow structures, thereby raising the internal pressure that counters the gravitational forces. Natural compression is particularly advantageous when the reverse rate of the chemical reaction that produced the transformation of the seed is slow compared to the rate of the chemical reaction that produces the gas.

An example method of fixed pressure can realize a desired internal pressure generated by a thermal gradient where the lower layer of hollow structures is at a higher temperature than those above. The temperature gradient creates a pressure differential, with the high internal pressure in the lower hollow structures counteracting the weight of the upper layers of hollow structures.

The transformation of seeds into hollow structures that become Boards can be accomplished by a heating process. That process should retain a thermal gradient (wherein the bottom layer is hotter than the top layer) across the multiple layers of seeds once the temperature initiates the chemical reaction in the seeds' cores that produces the transformation. The heating process continues with the thermal gradient across the layers of the seeds. By this process, the internal gas pressure within the hollow structures in the bottom layer will be able to support mass above it. By maintaining the thermal gradient, the condition just described occurs in each layer supporting the mass of layers above it. In other words, the bottom layer can have the most weight on it, but also have the highest internal pressure, whereas the top layer can have no weight on it, but also have the lowest internal pressure.

Seeds can be transformed into a hollow structure by reducing pressure and, in the process, creating a thermal gradient. Heating the layers of seeds to a temperature below that used to initiate the chemical reaction in the seeds' cores that transforms the seeds into hollow structures, then reducing the pressure below that which prevents the reaction from occurring in all cores initiates the transformation process. The chemical reaction occurring in the cores of the seeds is endothermic. The tray upon which the layers of seeds rests acts as a source of thermal energy, based on its mass and specific heat, or because it is continuously heated. The endothermic reaction occurring in the seeds in each layer limits heat transfer to the next layer and, by doing so, establishes the thermal gradient (highest temperature at the lowest layer). The temperature gradient causes the pressure within the hollow structures in the lower layers to be greater than those above. Thus, the lower layer of hollow structures can support the gravitational forces associated with the mass of material above it.

Alternatively, a temperature gradient across the layers of seeds can be established prior to reducing the pressure to trigger the transformation process. The gradient can be produced by heating the tray containing the seeds to a temperature above that of the surrounding gas used to heat the stacked layers of seeds.

Cooling the transformed layers, now a Board, produces a reduction in the internal gas pressure in the hollow structures. The cooling can be accomplished without collapsing the hollow structures. The factors that can be used in maintaining the hollow structures during cooling are wall thickness, viscosity, and pressure.

A Board's weight can be reduced by decreasing the wall thickness of the hollow structures, mainly those in the upper layers. Increasing the thickness of the walls supporting the most weight will reduce the deformation of the walls and ceilings supporting that additional mass. This applies to both transformation of seeds in multiple layers and in the cooling of the Boards.

Hollow structures that experience greater weight can have seeds printed that will produce thicker walls upon transformation (e.g., by altering the mass, composition, and/or shape, etc. of the coating). Thus, in printing layers of seeds it is possible to gradually reduce the mass of coating material in each added layer to reduce wall thickness of hollow structures, and the overall weight.

Viscosity, composition, and temperature are interdependent. A viscosity too low can cause thin walls and bring on collapse of the hollow structures. Too high a viscosity can impede the transition of a seed into a hollow structure of the desired shape. Increasing temperature decreases viscosity of a glass while increasing its silica content increases viscosity. Therefore, the inventor has identified novel processes for preventing collapse of hollow structures during production of a Board, by advantageously accounting for the interdependency of factors affecting the transformation of the seeds and cooling of the Board.

As an example, rapidly cooling a Board is a solution to prevent collapse of the hollow structures. However, with thicker Boards, removing the heat uniformly from the interior of the board is problematic. Rapid cooling on exposed surfaces is possible, lowering the temperature by 200 to 300° C. (this particular temperature reduction is by way of example and is not to be considered as limiting) can increase the viscosity of the glass walls of a hollow structure to a point where the collapse of the hollow structure due to gravity becomes very slow compared to the rate of heat removal. The viscosity of the wall of a hollow structure can be increased by boosting its silica content. Since the hollow structures are formed from printed seeds, it is possible to adjust the silica content of each layer of the coating material of a seed to produce glass walls with a higher viscosity in order to combat the forces that would collapse a hollow structure during cooling.

Once the temperature of an entire Board is 200 to 300° C. below the temperature used to transform the seeds, the increased viscosity greatly slows collapse of the hollow structures. Thermally soaking the Board at one or more temperatures can relieve stress and allow for some homogenization of composition in the glass walls.

Reducing the external pressure (e.g., via pressure regulating enclosure 406) provides a uniform means for cooling without collapsing the hollow structures. With cooling there is a decline in the internal pressure of a hollow structure. With that decline in the internal pressure, the same or slightly larger decline in the exterior pressure can keep the top layer of the hollow structures inflated until the cooling is sufficient to increase the viscosity in the walls, thereby preventing any collapse of the hollow structures during further cooling.

During cooling of the Board, coordination between the decrease in the external pressure and the temperature gradient across the layers of hollow structures can avoid unwanted distortion of the hollow structures in the lower layers, where too high a temperature can produce unwanted expansion of the sealed voids when the external pressure is decreased. The reduced external pressure being equal to, or slightly less than, the internal pressure in the hollow structures in the top layer fixes the temperature of the top layer, a value that can be computed using chemical thermodynamics.

A desirable temperature for the lowest layer of the hollow structures can be determined by knowledge of the external pressure and the magnitude of the gravitational forces applied per unit area perpendicular to the force at the lowest layer of the hollow structures. With that information one can compute an ideal temperature at the bottom layer using chemical thermodynamics.

While cooling the board, it is advantageous to maintain the relationship between the thermal and pressure gradients. In the cooling process, as the temperature of the upper layer of the hollow structures drops, the external pressure can also decline to avoid collapsing that layer of hollow structures. That decrease in external pressure can be paired advantageously with a drop in the temperature at the bottom layer of the hollow structures to avoid potentially unwanted expansion. Initially, coordination between the temperature and pressure gradients across the Board can help to avoid the collapse of the upper layer of hollow structures and to avoid the unwanted expansion of the hollow structures in the bottom layer. With continued cooling, the increase in the viscosity of the glass walls in the upper layer begins to fix the shape of the sealed voids and a more aggressive temperature gradient can be employed by lowering the top temperature to increase the rate of cooling.

Once the temperature of the entire Board is 200 to 300° C. below the temperature used to transform the seeds into hollow structures, the increased viscosity of the walls of the hollow structures greatly slows any collapse of the hollow structures. Thermally soaking the Board at one or more temperatures can also relieve internal stress.

With the novel pressure technique presented here for cooling, the use of additional silica to alter viscosity of the glass forming the walls is no longer needed, and, thus, thermally soaking the Board to homogenize the composition of the walls can be eliminated. Additional information regarding the use of silica to alter the viscosity in order to maintain the shape of hollow structures can be found in U.S. application Ser. No. 17/002,645 filed by the same inventor and entitled “Methods for Producing Hollow Ceramic Spheres”, which is incorporated herein by reference in its entirety.

The examples presented here for cooling the Boards are not intended to be and should not be considered as limiting.

It is desirable to maintain a particular shape (e.g., hexagonal, rectangular, spherical, etc.) of the hollow structures. There is a natural process where materials try to reduce their surface energy by forming a sphere, a shape that has the lowest surface energy per unit volume. That natural process is more prevalent in submicron particles and in materials at elevated temperatures. In larger structures, physical means can be used to fix shape and thereby reduce the predisposition of a material to form a sphere. The physical means to establish a desired shape with hollow glass structures can include printing the seed's core in the desired two horizontal directions, constraining horizontal deviation of that shape using physical boundaries, and by increasing the viscosity of the walls that are formed during transformation.

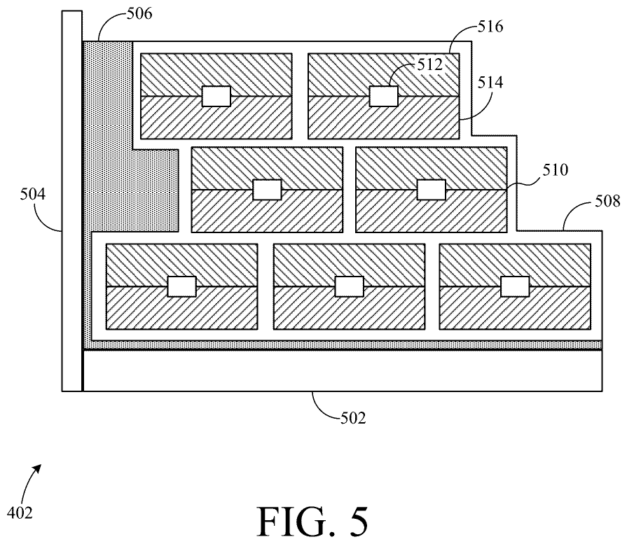

FIG. 5 is a block diagram showing a sectional view of a portion of tray 402. Tray 402 includes a base 502 and a sidewall 504. A release agent 506 is applied to the top surface of base 502 and inner surface of sidewall 504 in order to easily remove the created board from tray 402 after transformation of the seeds. A glass frit 508 is then applied over release agent 506. The exact amount and composition of the glass frit can be tailored according to this disclosure to control the viscosity, wall thickness, etc. of the hollow structures during and after transformation of the seeds. Seeds 510 and additional glass frit 508 are alternatingly applied over glass frit 508. Each of seeds 510 includes a core 512, a lower coating 514, and an upper coating 516. The lower coatings 514 of a plurality of seeds 510 are applied over/alongside glass frit 508, cores 512 of said plurality of seeds 510 are applied over lower coatings 514/alongside glass frit 508, and upper coatings 516 are applied over cores 512 and lower coatings 514/alongside glass frit 508.

FIG. 5 illustrates the concept of offsetting the walls of the hollow structures in adjacent layers. As the seeds are transformed and expand against one another, the walls will take up roughly the area of glass frit 508 between seeds 510. As can be seen from FIG. 5, these areas of glass frit 508 are horizontally offset between the layers, increasing the tortuosity of heat through the resultant hollow structures.

Because, the glass frit 508, core 512, lower coating 514, and upper coating 516 are all comprised of particulate, seeds 510 in the GST can be printed in any shape. In a particular, non-limiting example, the seeds can be printed so that their primary axis (i.e., longest axis) is horizontal, and so that horizontal growth is constrained by a tray's vertical walls and adjacent seeds. In this case, only vertical growth occurs during transformation of a seed into a hollow structure. The transformation is accomplished by printing the core of a seed in the desire horizontal shape (e.g., rectangular, hexagonal, etc.) on coating material, and by placing a layer of coating material over the top of the core. In printing seeds, a layer of silica powder or a high silica glass frit can be placed between seeds or in a portion of the coating material of the seed. Upon transforming seeds into hollow structures, the extra silica (as silica or a high silica glass frit) locally increases the viscosity of the glass as the walls begin forming, helping to retain the desired shape achieved in printing the core. As the transformation proceeds, more of the silica dissolves into the glass as the walls continue forming, raising the viscosity of the walls and helping to prevent significant distortion in the desired shape of the hollow structures. After the Board is formed and has undergone cooling to fix the shape of the hollow structures, it can be soaked at a temperature to reduce concentration gradients in the glass walls and to relieve stress while the viscosity of the glass is high enough to prevent any significant change in shape of the hollow structures. More information regarding the generation of hollow structures from seeds can be found in U.S. patent application Ser. No. 17/530,963, filed by the same inventor and entitled “Methods for Producing Seed for Growth of Hollow Spheres”, which is incorporated herein by reference in its entirety.

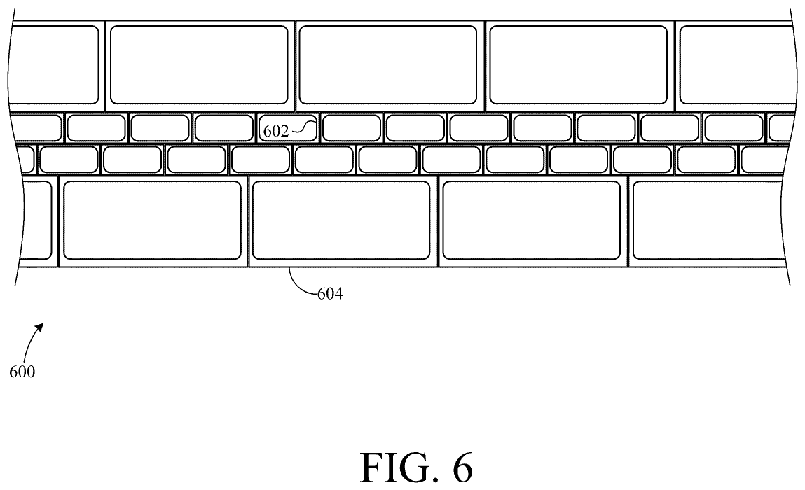

FIG. 6 shows an example portion 600 of a Board configured to optimally distribute forces during and after transformation of seeds. During the transformation of multiple layers of offset seeds, the distribution of gravitational forces may be required to avoid collapse or partial collapse of hollow structures in lower layers. The forces can be distributed by producing one or more layers of smaller hollow structures 602 between layers of the larger hollow structures 604 as presented in FIG. 6. The smaller sealed structures 602 can be offset so that their vertical walls are not aligned with respect to the vertical walls of the larger hollow structures 604 above and below them. Thus, the vertical gravitational forces are distributed, an example being, the force from one vertical wall split and transferred to two vertical walls. The use of sealed, rectangular solids in FIG. 6 is for illustrative purpose and is not to be considered as limiting.

Alternatively a layer of silica powder or a layer of high silica glass frit can be printed in the horizontal top surface of a seed whereupon transformation, the vertical wall of a hollow structure in the layer above contacts the top surface of the hollow sealed structure below that has the additional silica. The added silica raises the viscosity of the top surface, thereby helping it to resist the gravitational force of the vertical wall above it by slowing any deformation of the horizontal surface below the vertical wall.

A series of layers of small hollow structures, as shown in FIG. 6, can be advantageously included on all exterior surfaces of the Boards to minimize the impact of atmospheric pressure on the Boards whose sealed structures have internal pressure less than 1 atmosphere. The higher the external pressure exerted on a Board, the greater the benefit of additional layers of the small hollow structures on the exterior surface of the Board.

Alternatively, increasing the wall thickness of the hollow structures exposed to the surrounding atmospheric pressure can, through the printing of seeds, reduce the need for the additional layers of the small hollow structures.

It is also possible to create a pressure gradient in the hollow structures that are on the exterior of the Boards to counter the exterior pressure. That increase in pressure would likely involve heating a Board in an atmosphere where the gas can diffuse into the interior of the hollow structures on the exterior of the Board, and upon cooling, the gas remains trapped within those hollow structures.

The description of particular embodiments of the present invention is now complete. Many of the described features may be substituted, altered or omitted without departing from the scope of the invention. For example, rather than generating a plurality of congruent hollow structures, a single Board can include a plurality of different shaped and sized hollow structures. These and other deviations from the particular embodiments shown will be apparent to those skilled in the art, particularly in view of the foregoing disclosure.

We claim:

1. A method for manufacturing an insulating board, said method comprising:
providing a tray having a bottom surface and a plurality of sidewalls;
printing on said bottom surface of said tray a plurality of seeds in a first layer;
printing on said plurality of seeds in said first layer a plurality of seeds in a second layer, a center of each seed of said second layer being horizontally offset from a center of each seed of said first layer;
printing on said plurality of seeds in said second layer a plurality of seeds in a third layer, a center of each seed of said third layer being horizontally offset from a center of each seed of said first layer and said second layer; and
heating said tray to transform said seeds into a plurality of hollow structures.
